(19) United States
(12) Patent Application Publication
(10) Pub. No.: US 2014/0251287 A1
(43) Pub. Date: Sep. 11, 2014

(54) EGR CONTROLLER FOR INTERNAL COMBUSTION ENGINE

(71) Applicant: DENSO CORPORATION, Kariya-city (JP)

(72) Inventor: Hiroyuki TAKEZOE, Tokai-city (JP)

(73) Assignee: DENSO CORPORATION, Kariya-city (JP)

(21) Appl. No.: 14/196,232

(22) Filed: Mar. 4, 2014

(30) Foreign Application Priority Data
Mar. 5, 2013 (JP) 2013-43173

(51) Int. Cl. F02D 41/00

(52) U.S. Cl. CPC F02D 41/0052
USPC 123/568.11

(57) ABSTRACT

While an EGR valve is closed, a total gas flow rate is computed based on an intake air pressure. An error of the total gas flow rate is learned and corrected. When the EGR valve is opened, the total gas flow rate is computed based on the intake air pressure. An actual EGR-gas flow rate is computed based on the total gas flow rate and a fresh-air flow rate. By using of the EGR valve model, an estimated EGR-gas flow rate is computed based on the fresh-air flow rate and an opening degree of the EGR valve. An error of the estimated EGR-gas flow rate is learned and corrected based on the actual EGR-gas flow rate and the estimated EGR-gas flow rate. Based on a volume fraction of the corrected estimated EGR-gas flow rate and the fresh-air flow rate, an EGR ratio is computed.

### CROSS-REFERENCE TO RELATED APPLICATION

This application is based on Japanese Patent Application No. 2013-43173 filed on Mar. 5, 2013, the disclosure of which is incorporated herein by reference.

### TECHNICAL FIELD

The present invention relates to an exhaust gas recirculation (EGR) controller for an internal combustion engine, which is provided with an EGR valve which controls an exhaust gas flow rate recirculating from an exhaust pipe into an intake pipe.

### BACKGROUND

An internal combustion engine having an EGR system is well known. The EGR system has an EGR valve which adjusts a flow rate of an exhaust gas (EGR-gas flow rate) recirculating from an exhaust pipe into an intake pipe. The EGR-gas flow rate may vary relative to a target quantity due to a manufacture variation or an aged deterioration, etc. of the EGR system.

Japanese Patent No. 4075027 shows an EGR system in which an actual EGR-gas flow rate is corrected according to a standard-atmospheric-pressure and a standard-airflow-rate, and a deviation of the EGR-gas flow rate is computed based on a difference between the corrected EGR-gas flow rate and a reference EGR-gas flow rate. Then, a controlled variable of an EGR valve is corrected based on an EGR variation ratio which is obtained from the deviation of the EGR-gas flow rate.

In order to improve a fuel economy, in an EGR system, an EGR ratio is increased so that the EGR-gas flow rate is increased more than a conventional system. However, when it is in a high EGR ratio (for example, 20% or more), a sensitivity of deterioration of drivability becomes high relative to a variation in EGR ratio. Moreover, when it is in a high EGR ratio, it is likely that an error of the EGR ratio obtained based on a mass fraction becomes larger as shown in FIG. 8. In an engine control system which is operated based on the EGR ratio, according as the error of the EGR ratio becomes larger, an accuracy of the control is more deteriorated, so that the drivability may be deteriorated. Even the above described EGR system shown in Japanese Patent No. 4075027 can not avoid such deterioration in drivability.

### SUMMARY

It is an object of the present disclosure to provide an exhaust gas recirculation (EGR) controller for an internal combustion engine, which is able to accurately obtain an EGR ratio and improve an accuracy of a control which is operated based on the EGR ratio.

According to the present disclosure, an EGR controller has an EGR valve, an intake air flow rate obtaining portion detecting or estimating a fresh-air flow rate, and an intake pressure detecting portion detecting an intake air pressure.

Further, the EGR controller has a total-flow-rate computing portion computing a total gas flow rate flowing into a cylinder of the internal combustion engine, based on the intake air pressure; an actual-EGR computing portion computing an actual EGR-gas flow rate based on the total gas flow rate and the fresh-air flow rate; an estimated-EGR computing portion computing an estimated EGR-gas flow rate flowing through the EGR valve by means of an EGR valve model simulating a behavior of a recirculated exhaust gas passing through the EGR valve in the EGR passage; a first learning correction portion learning and correcting an error of the estimated EGR-gas flow rate based on the actual EGR-gas flow rate and the estimated EGR-gas flow rate; and an EGR-ratio computing portion computing an EGR ratio based on volume fractions of the estimated EGR-gas flow rate and the fresh-air flow rate.

An error of the estimated EGR-gas flow rate is learned and corrected based on the actual EGR-gas flow rate and the estimated EGR-gas flow rate. The error of the estimated EGR-gas flow rate due to production tolerance and/or aged deterioration (model error of the intake valve model) can be corrected, so that the computation accuracy of the estimated EGR-gas flow rate can be improved. An EGR ratio is computed based on the volume fraction of the estimated EGR-gas flow rate and the fresh-air flow rate. Thus, the EGR ratio can be computed more accurately than a case that the EGR ratio is computed based on a mass fraction. A control accuracy of a control conducted based on the EGR ratio can be improved.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of an engine control system according to an embodiment;

FIG. 2 is a block diagram for explaining a learning correction of a total-gas-quantity error;

FIG. 3 is a block diagram for explaining a learning correction of an estimated-EGR error and a computation of an EGR ratio;

FIGS. 4 and 5 are flow charts showing a routine in which a learning correction and an EGR ratio computation are conducted;

FIG. 6 is a time chart showing a flow rate error and a learning correction value;

FIG. 7 is a chart conceptually showing a map of a learning correction value; and

FIG. 8 is a chart for explaining an advantage of the disclosure.

### DETAILED DESCRIPTION

An embodiment will be described hereinafter.

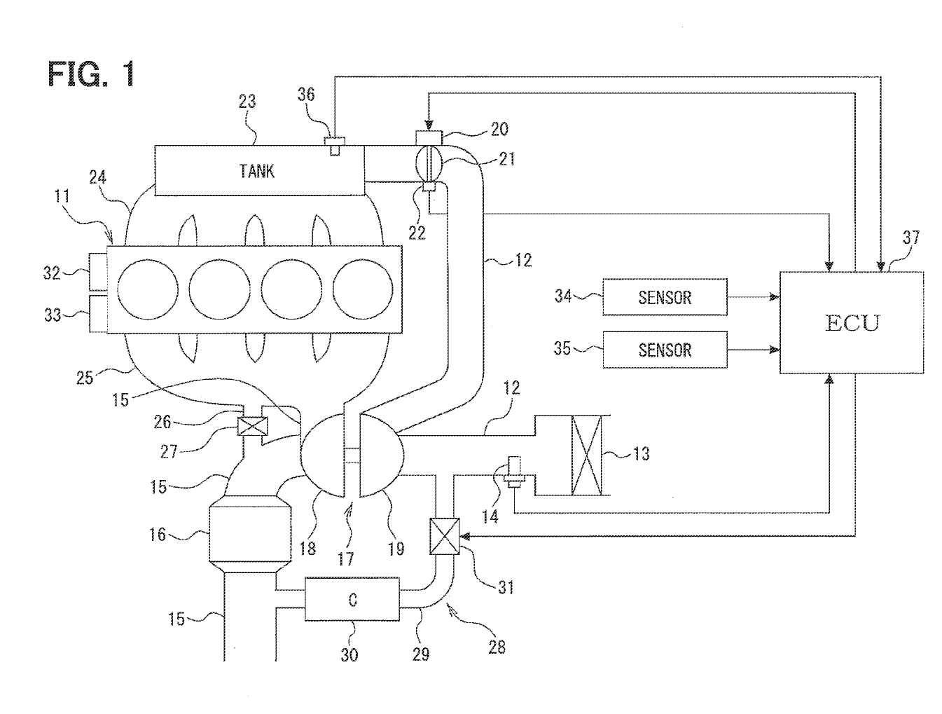

First, referring to FIG. 1, an engine control system is schematically explained. An air cleaner 13 is arranged upstream of an intake pipe 12 (intake passage) of an internal combustion engine 11. An airflow meter 14 (intake air flow rate obtaining portion) detecting an intake air flow rate is provided downstream of the air cleaner 13. An exhaust pipe 15 (exhaust passage) of the engine 11 is provided with a three-way catalyst 16 which reduces CO, HC, NOx, and the like contained in exhaust gas.

The engine 11 is provided with a turbocharger 17. The turbocharger 17 includes an exhaust gas turbine 18 arranged upstream of the catalyst 16 in the exhaust pipe 15 and a compressor 19 arranged downstream of the airflow meter 14 in the intake pipe 12. This turbocharger 17 has well known configuration which supercharges the intake air into the combustion chamber.

A throttle valve 21 driven by a DC-motor 20 and a throttle position sensor 22 detecting a throttle position (throttle opening degree) are provided downstream of the compressor 19.

Furthermore, an intake pressure sensor 36 detecting an intake air pressure is provided downstream of the throttle valve 21. An intercooler (not shown) is provided in a surge tank 23. The intercooler may be arranged upstream of the surge tank 23 and the throttle valve 21. An intake manifold 24 (intake passage) which introduces air into each cylinder of the engine 11 is provided downstream of the surge tank 23, and a fuel injector (not shown) which injects fuel is provided for each cylinder. A spark plug (not shown) is mounted on a cylinder head of the engine 11 corresponding to each cylinder to ignite air-fuel mixture in each cylinder.

An exhaust manifold 25 (exhaust passage) is connected to each exhaust port of the cylinder. A confluent portion of the exhaust manifold 25 is connected to the exhaust pipe 15 upstream of the exhaust gas turbine 18. An exhaust bypass passage 26 bypassing the exhaust gas turbine 18 is connected to the exhaust pipe 15. A waste gate valve (WGV) 27 is disposed in the exhaust bypass passage 26 to open/close the exhaust bypass passage 26.

The engine 11 is provided with an exhaust gas recirculation (EGR) apparatus 28 for recirculating a part of exhaust gas from the exhaust pipe 15 into the intake pipe 12. This EGR apparatus 28 is referred to as low-pressure-loop (LPL) type. The EGR apparatus 28 has an EGR pipe (EGR passage) 29 connecting a downstream portion of the exhaust gas turbine 18 and an upstream portion of the compressor 19. An EGR cooler 30 for cooling the EGR-gas and an EGR valve 26 for adjusting the EGR-gas flow rate are provided in the EGR pipe 29. An opening degree of the EGR valve 31 is adjusted by a motor (not shown). When the EGR valve 31 opens the EGR pipe 29, a part of exhaust gas (EGR-gas) is recirculated from the exhaust pipe 15 to the intake pipe 12 through the EGR pipe 29.

The engine 11 is provided an intake-side variable valve timing controller 32 which adjusts a valve timing of an intake valve (not shown), and an exhaust-side variable valve timing controller 33 which adjusts a valve timing of an exhaust valve (not shown). Further, the engine 11 is provided with a coolant temperature sensor 34 detecting coolant temperature and a crank angle sensor 35 outputting a pulse signal every when the crank shaft (not shown) rotates a specified crank angle. Based on the output signal of the crank angle sensor 35, a crank angle and an engine speed are detected.

The outputs of the above sensors are transmitted to an electronic control unit (ECU) 37. The ECU 37 includes a microcomputer which executes an engine control program stored in a Read Only Memory (ROM) to control a fuel injection quantity, an ignition timing, a throttle position (Intake air flow rate) and the like.

The ECU 37 computes a target EGR ratio according to an engine driving condition, such as an engine speed and an engine load. Further, the ECU 37 computes an EGR ratio based on an estimated EGR-gas flow rate which will be described later. The ECU 37 feedback controls the opening degree of the EGR valve 31 in such a manner that the EGR ratio agrees with a target EGR ratio. Also, based on the EGR ratio, the ECU 37 corrects an ignition timing, an intake valve timing, and an exhaust valve timing.

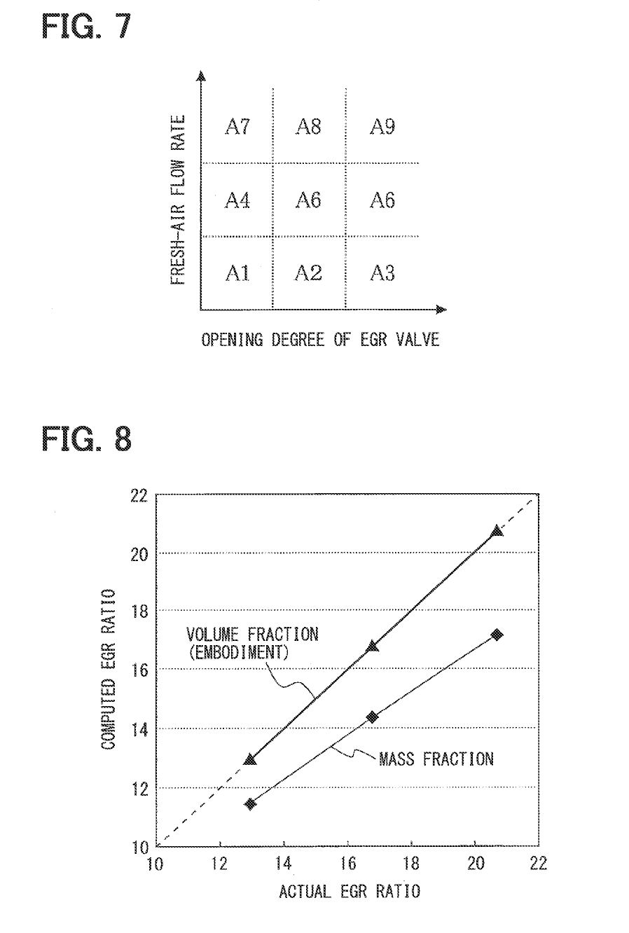

The EGR-gas flow rate may vary relative to a target quantity due to a production tolerance or an aged deterioration of the EGR apparatus 28. Also, in order to improve a fuel economy, an EGR ratio is increased so that the EGR-gas flow rate is increased more than a conventional system. However, when it is in a high EGR ratio (for example, 20% or more), a sensitivity of deterioration in drivability becomes high relative to a variation in EGR ratio. Moreover, when it is in a high EGR ratio, it is likely that an error of the EGR ratio, which is obtained based on a mass ratio, becomes larger as shown in FIG. 8. In an engine control system which is operated based on the EGR ratio, according as the error of the EGR ratio becomes larger, an accuracy of the control is more deteriorated, so that the drivability may be deteriorated.

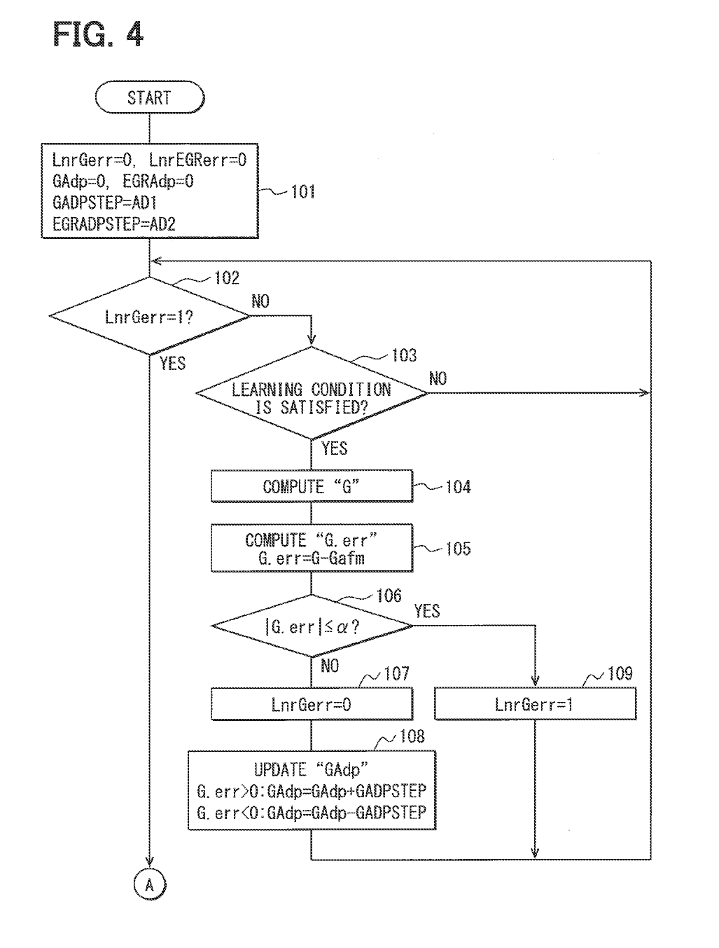

According to the present embodiment, the ECU 37 executes a routine shown in FIGS. 4 and 5 so as to compute the EGR ratio. First, when the EGR valve 31 is fully closed and the EGR-gas flow rate is zero, the ECU 37 computes a total gas flow rate based on the intake air pressure detected by the intake pressure sensor 36. In this case, the total gas flow rate corresponds to a fresh-air flow rate. Then, the ECU 37 makes a comparison between the computed total gas flow rate and the fresh-air flow rate detected by the airflow meter 14. Based on a comparison result, the ECU 37 learns and corrects an error of the computed total gas flow rate.

Then, when the EGR valve 31 is opened, the ECU 37 computes the total gas flow rate introduce into the cylinders based on the intake air pressure detected by the intake pressure sensor 36. In this case, the total gas flow rate corresponds to a sum of the fresh-air flow rate and the EGR-gas flow rate. Further, the ECU 37 computes an actual EGR-gas flow rate based on the total gas flow rate and the fresh-air flow rate detected by the airflow meter 14. Also, the ECU 37 computes an estimated EGR-gas flow rate by means of an EGR valve model which simulates a behavior of the EGR-gas passing through the EGR valve 31 in the EGR pipe 29. Then, the ECU 37 makes a comparison between the actual EGR-gas flow rate and the estimated EGR-gas flow rate. Based on a comparison result, the ECU 37 learns and corrects an error of the estimated EGR-gas flow rate. The EGR ratio is obtained based on a volume fraction of the estimated EGR-gas flow rate.

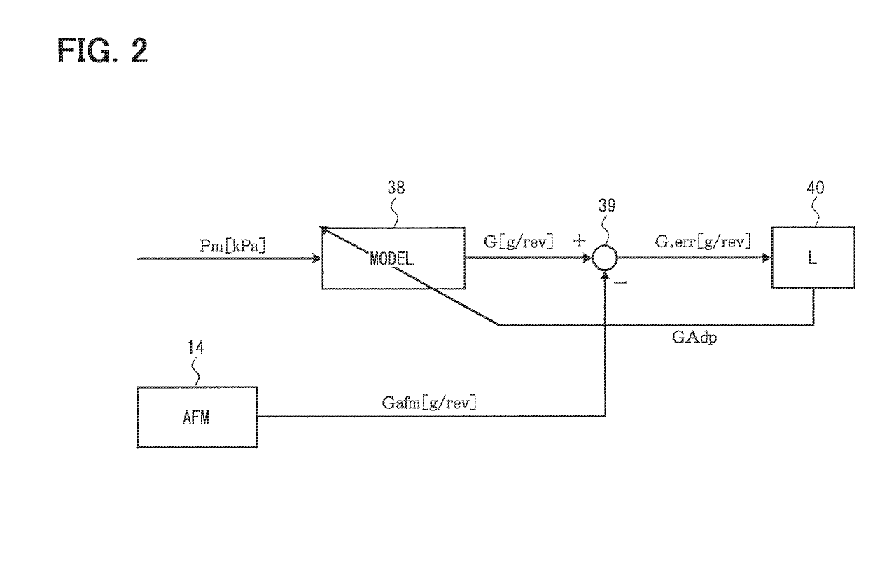

Specifically, as shown in FIG. 2, when the EGR valve 31 is fully closed and the EGR-gas flow rate is zero, a total-flow-rate computing portion 38 computes a total gas flow rate G [g/rev] flowing into the cylinders based on the intake air pressure Pm [kPa] detected by the intake pressure sensor 36, by using of an intake valve model (map, mathematical formula etc.). The intake valve model simulates a behavior of the gas flowing into the cylinder. In this case, the total gas flow rate G corresponds to the fresh-air flow rate.

Then, a deviation portion 39 computes a deviation between the total gas flow rate G [g/rev] and the fresh-air flow rate Gafm detected by the air flow meter 14. The computed deviation is defined as an error G.err [g/rev] of the total gas flow rate. Then, a learning portion 40 updates a learning correction value GAdp by a specified step amount so that the error G.err becomes smaller. The intake valve model is corrected based on the learning correction value GAdp, whereby the error G.err is corrected. The above deviation portion 39 and the learning portion 40 correspond to a second learning correction portion.

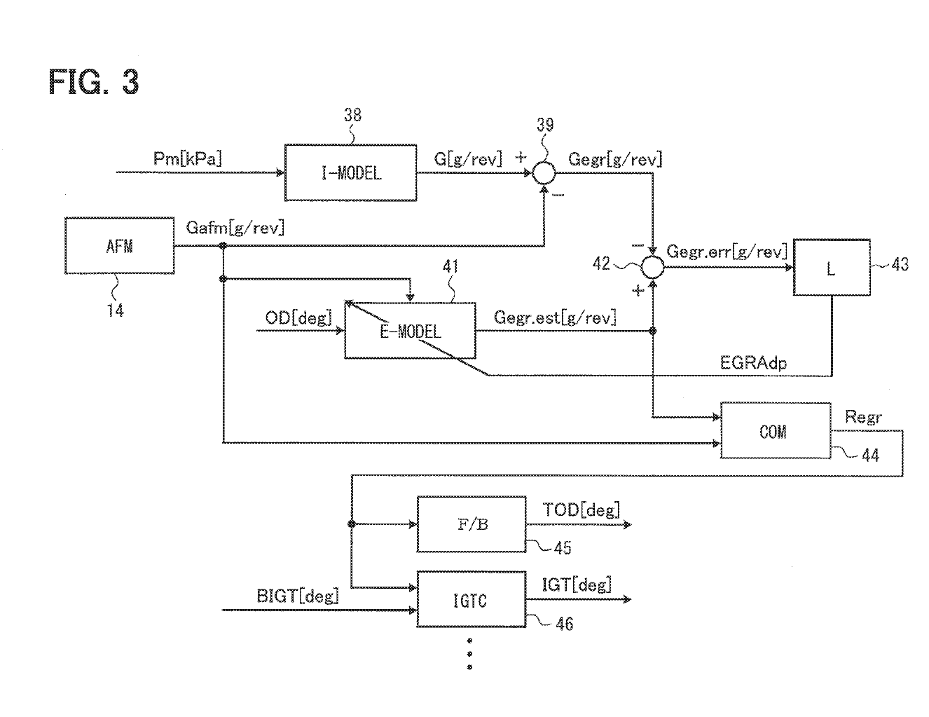

As shown in FIG. 3, when the EGR valve 31 is opened, the total-flow-rate computing portion 38 computes the total gas flow rate G [g/rev] introduced into the cylinders based on the intake air pressure Pm [kPa] detected by the intake pressure sensor 36, by using of the intake valve model. In this case, the total gas flow rate G corresponds to a sum of the fresh-air flow rate and the EGR-gas flow rate. Then, a deviation portion 39 (actual-EGR computing portion) computes a deviation between the total gas flow rate G [g/rev] and the fresh-air flow rate Gafm [g/rev] detected by the air flow meter 14. The computed deviation is defined as an actual EGR-gas flow rate Gegr [g/rev].

Moreover, an estimated-EGR computing portion 41 computes an estimated EGR-gas flow rate Gegr.est [g/rev] based on the fresh-air flow rate Gafm [g/rev] and an opening degree OD of the EGR valve 31, by using of the EGR valve model which simulates a behavior of the EGR-gas passing through the EGR valve 31 in the EGR pipe 29.

A deviation portion 42 computes a deviation between the estimated EGR-gas flow rate Gegr.est [g/rev] and the actual EGR-gas flow rate Gegr [g/rev]. The computed deviation is defined as an error Gegr.err [g/rev] of the estimated EGR-gas flow rate. Then, a learning portion 43 updates a learning correction value EGRAdp by a specified step amount so that the error Gegr.err of the estimated EGR-gas flow rate becomes smaller. The EGR valve model is corrected based on the learning correction value EGRAdp, whereby the error Gegr.err of the estimated EGR-gas flow rate is corrected. In this case, the above deviation portion 42 and the learning portion 43 correspond to a first learning correction portion.

Then, an EGR-ratio computing portion 44 computes an EGR-ratio Regr based on a volume fraction of the estimated EGR-gas flow rate Gegr.est [g/rev] and the fresh-air flow rate Gafm [g/rev]. It should be noted that a specific computing method of the EGR-ratio Regr will be described later.

Then, an EGR-valve-FB-control portion 45 feedback-controls the opening degree OD of the EGR valve 31 in such a manner that the EGR-ratio Regr agrees with a target EGR ratio. For example, the EGR-valve-FB-control portion 45 computes a target EGR valve opening degree TOD and drives the EGR valve 31 so that its opening degree OD agrees with the target EGR valve opening degree TOD.

Moreover, an ignition-timing-correction portion 46 corrects an ignition timing IGT according to the EGR-ratio Regr. Specifically, an ignition timing correction quantity is computed according to the EGR ratio, and a base ignition timing BIGT is corrected based on the ignition timing correction quantity.

Next, the computing method of the EGR-ratio Regr will be described hereinafter.

The EGR-ratio Regr [%] is defined as a following formula (1).

$$Regr = \frac{{CO}_{2 in} - {CO}_{2 air}}{{CO}_{2 ex} - {CO}_{2 air}} \times 100 \qquad ( 1 )$$

In the formula (1), CO₂ in represents a volume concentration [vol %] of carbon dioxide (CO₂) in the gas flowing through the intake manifold 24, CO₂ ex represents a volume concentration [vol %] of CO₂ in the gas flowing through the exhaust manifold 25, and CO₂ air is volume concentration [vol %] of CO₂ in atmospheric air (fresh-air).

A relation between a mass flow rate Gegr [g/sec] of the EGR-gas and a volume flow rate Vegr [L/sec] of the EGR-gas can be expressed by following formula (2).

$$Gegr = \frac{Megr}{22.4} \times \frac{Tstd}{Tstd + Tin} \times \frac{Pin}{Pstd} \times Vegr \qquad ( 2 )$$

In the above formula (2), Tstd [k] represents a standard temperature (for example, 273-[K]) and Tin [° C.] represents a temperature in the intake manifold 24. That is, Tin represents an EGR-gas temperature. Pstd [kPa] represents a standard pressure (for example, 101.325 [kPa]), and Pin [kPa] represents a pressure in the intake manifold 24.

Megr [g/mol] represents a mass per 1 mol of the EGR-gas. The volume fraction of the EGR-gas and the volume fraction of the fresh-air are defined as follows. In the present embodiment, it is assumed that the volume fractions of CO₂ and H₂O in the EGR-gas are 14.5%.

It is assumed that the volume fraction of the EGR-gas is follows:

N₂:O₂:H₂O:CO₂=71:0:14.5:14.5

It is assumed that the volume fraction of the fresh-air is follows:

N₂:O₂:H₂O:CO₂=78:22:0:0

In this case, Megr [g/mol] is about 28.9 and is substantially equal to mass Mair [g/mol] of the fresh-air per 1 mol.

Also, the volume flow rate Vegr [L/sec] of the EGR-gas can be expressed by following formula (3) which employs a volume flow rate Vair of the fresh-air and the EGR-ratio Regr [%].

$$Vegr = \frac{Vair}{100 - Regr} \times \frac{Regr}{100} \qquad ( 3 )$$

Further, the volume flow rate Vair [L/sec] of the fresh-air can be expressed by following formula (4) which employs a mass flow rate Gair [g/sec] of the fresh-air.

$$Vair = Gair \times \frac{1.293 \times P}{1 + 0.00367 \times t} \qquad ( 4 )$$

In the above formula (4), P [atm] represents an atmospheric pressure, and t [° C.] represents an intake air temperature in the vicinity of the air flow meter 14, for example.

The EGR-ratio Regr [%] can be expressed by following formula (5) derived from the above formula (3).

$$Regr = \frac{10000 \times Vegr}{Vair + 100 \times Vegr} \qquad ( 5 )$$

The volume flow rate Vegr [L/sec] of the EGR-gas can be expressed by following formula (6) derived from the above formula (2).

$$Vegr = Gegr / ( \frac{Megr}{22.4} \times \frac{Tstd}{Tstd + Tin} \times \frac{Pin}{Pstd} ) \qquad ( 6 )$$

In the present embodiment, the EGR-ratio Regr [%] is computed according to the above formulas (4)-(6).

Specifically, the mass flow rate Gair [g/sec] of the fresh-air, which is obtained from the fresh-air flow rate Gafm [g/rev] detected with the air flow meter 14, is substituted into the formula (4). Further, the intake air temperature t [° C.] and the atmospheric pressure P [atm] detected with a pressure sensor (not shown) are substituted into the formula (4), whereby the volume flow rate Vair [U/sec] is obtained.

Moreover, the mass flow rate Gegr [g/sec] derived form the estimated EGR-gas flow rate Gegr.est [g/rev], the temperature Tin [° C.], and the pressure Pin [kPa] detected by the intake pressure sensor 36 are substituted into the formula (6), whereby the volume flow rate Vegr [L/sec] of EGR-gas is calculated.

Then, the volume flow rate Vair [L/sec] and the volume flow rate Vegr [L/sec] are substituted into the formula (5), whereby the EGR-ratio Regr [%] is obtained. That is, the EGR-ratio Regr [%] is a volume ratio.

The ECU 37 executes the above described computation of the EGR ratio and the learning corrections of the total gas flow rate error and the estimated EGR-gas flow rate error according to a routine shown in FIGS. 4 and 5. The process of this routine will be described hereinafter.

In step 101, an initialization process is executed. A total-gas-flow-rate-error learning flag LnerGerr is reset to “0”, and an estimated-EGR-error learning flag LnrEGRerr is reset to “0.” Moreover, the learning correction value GAdp of the total-gas-quantity error is set to an initial value (for example, “1”), and the learning correction value EGRAdp of the estimated-EGR error is set to an initial value (for example, “1”). Furthermore, a step amount GADPSTEP of the learning correction value GAdp is set to an adaptation value AD1, and a step amount EGRADPSTEP of the learning correction value EGRAdp is set to an adaptation value AD2.

The procedure proceeds to step 102 in which it is determined whether the learning correction of the total-gas-quantity error is completed based on whether the total-gas-flow-rate-error learning flag LnerGerr is set to “1”

When the answer is NO in step 102, the procedure proceeds to step 103 in which it is determined whether a learning execution condition of the total-gas-quantity error is satisfied based on whether the engine 11 is normally running and the EGR valve 31 is closed.

When the answer is NO in step 103, the procedure goes back to step 102. When the answer is YES in step 103, the procedure proceeds to step 104 in which the total gas flow rate G [g/rev] is computed based on the intake air pressure Pm [kPa] detected by the intake pressure sensor 36, by using of the intake valve model.

Then, the procedure proceeds to step 105 in which the deviation between the total gas flow rate G [g/rev] and the fresh-air flow rate Gafm is computed as the error G.err [g/rev] of the total gas flow rate.

G.err=G−Gafm

Then, the procedure proceeds to step 106 in which an absolute value of the error G.err is less than or equal to a determination value α. When the answer is YES in step 106, the procedure proceeds to step 107 in which the total-gas-flow-rate-error learning flag LnerGerr is reset or maintained to “0.”

Then, the procedure proceeds to step 108 in which the learning correction value GAdp is updated by the step amount GADPSTEP so that the error G.err becomes smaller.

In this case, for example, when the error G.err is larger than zero, the learning correction value GAdp is increased by only the step amount GADPSTEP.

GAdp=GAdp+GADPSTEP

Meanwhile, when the error G.err is less than zero, the learning correction value GAdp is decreased by only the step amount GADPSTEP.

GAdp=GAdp−GADPSTEP

The intake valve model is corrected based on the learning correction value GAdp, whereby the error G.err is corrected.

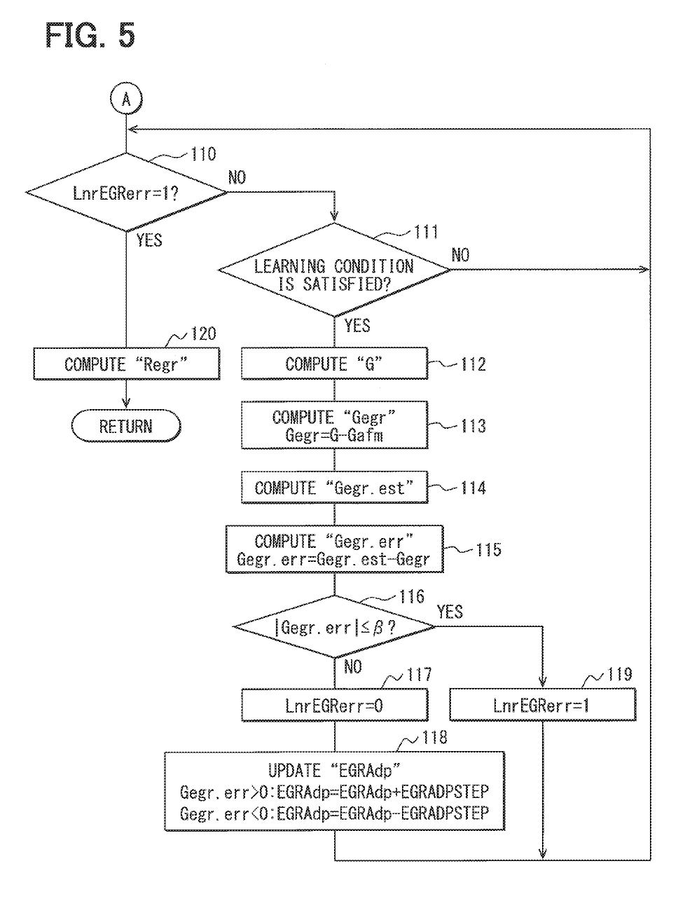

When the learning execution condition of the total-gas-quantity error is satisfied and the absolute value of the total-gas-quantity error G.err is greater than the determination value α, the learning correction value GAdp is updated at a specified period, whereby the error G.err is corrected to be decreased, as shown in FIG. 6. Besides, when the absolute value of the error G.err is greater than a specified value or when a learning frequency (update frequency of the learning correction value GAdp) is less than a specified value, an update frequency of a learning correction value GAdp may be increased. Also, when a mileage on a vehicle is less than a specified value, the update frequency of the learning correction value GAdp may be increased.

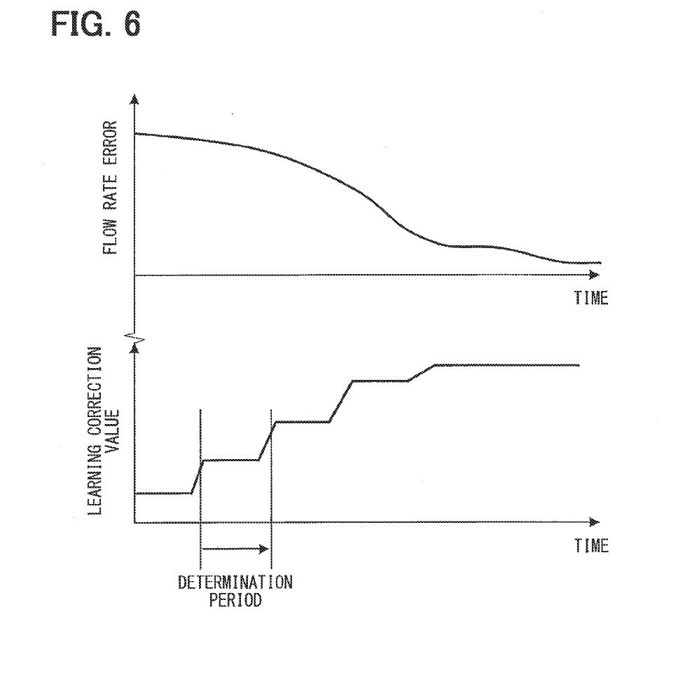

FIG. 7 shows a map of the learning correction value GAdp which is stored in a rewritable nonvolatile memory, such as a backup RAM of the ECU 37. The map of the learning correction value GAdp is divided into multiple learning areas (for example, A1-A9) of which parameters are an opening degree OD of the EGR valve 31 and the fresh-air flow rate. The learning correction value GAdp is stored in each learning area. The learning correction value GAdp in each learning area is updated according to the current opening degree OD of the EGR valve 31 and the current fresh-air flow rate.

The intake valve model is corrected based on the updated learning correction value GAdp.

When the answer is YES in step 106, the procedure proceeds to step 109 in which the total-gas-flow-rate-error learning flag LnerGerr is set to “1”.

When the answer is YES in step 102, the procedure proceeds to step 110 in which it is determined whether the learning correction of the estimated EGR-gas flow rate error is completed based on whether the estimated-EGR-error learning flag LnrEGRerr is set to “1.”

When the answer is NO in step 110, the procedure proceeds to step 111 in which it is determined whether a learning execution condition of the estimated EGR-gas flow rate error is satisfied based on whether the engine 11 is normally running and the EGR valve 31 is opened.

When the answer is NO in step 111, the procedure goes back to step 110.

When the answer is YES in step 111, the procedure proceeds to step 112 in which the total gas flow rate G [g/rev] is computed based on the intake air pressure Pm [kPa] detected by the intake pressure sensor 36, by using of the intake valve model.

Then, the procedure proceeds to step 113 in which the deviation between the total gas flow rate G [g/rev] and the fresh-air flow rate Gafm [g/rev] is computed as the actual EGR-gas flow rate Gegr [g/rev].

Gegr=G−Gafm

Then, the procedure proceeds to step 114 in which the estimated EGR-gas flow rate Gegr.est [g/rev] is computed based on the fresh-air flow rate Gafm [g/rev] and an opening degree OD of the EGR valve 31, by using of the EGR valve model.

Then, the procedure proceeds to step 115 in which a deviation between the estimated EGR-gas flow rate Gegr.est [g/rev] and the actual EGR-gas flow rate Gegr [g/rev] is computed. The computed deviation is defined as the error Gegr.err [g/rev] of the estimated EGR-gas flow rate Gegr.est.

Gegr.err=Gegr.est−Gegr

Then, the procedure proceeds to step 116 in which an absolute value of the error Gegr.err is less than or equal to a determination value B. When the answer is NO in step 106, the procedure proceeds to step 117 in which the estimated-EGR-error learning flag LnrEGRerr is reset or maintained to “0”.

Then, the procedure proceeds to step 118 in which the learning correction value EGRAdp is updated by the step amount EGRADPSTEP so that the error Gegr.err becomes smaller.

In this case, for example, when the error Gegr.err is larger than zero, the learning correction value EGRAdp is increased by only the step amount EGRADPSTEP.

EGRAdp=EGRAdp+EGRADPSTEP

Meanwhile, when the error Gegr.err is less than zero, the learning correction value EGRAdp is decreased by only the step amount EGRADPSTEP.

EGRAdp=EGRAdp−EGRADPSTEP

The EGR valve model is corrected based on the learning correction value EGRAdp, whereby the error Gegr.err of the estimated EGR-gas flow rate is corrected.

When the learning execution condition of the estimated-EGR error is satisfied and the absolute value of the estimated-EGR error Gegr.err is greater than the determination value β, the learning correction value EGRAdp is updated at a specified period, whereby the error Gegr.err is corrected to be decreased, as shown in FIG. 6. Besides, when the absolute value of the error Gegr.err is greater than a specified value or when a learning frequency (update frequency of the learning correction value EGRAdp) is less than a specified value, an update frequency of a learning correction value EGRAdp may be increased. Also, when a mileage on a vehicle is less than a specified value, the update frequency of the learning correction value EGRAdp may be increased.

FIG. 7 also shows a map of the learning correction value EGRAdp which is stored in a rewritable nonvolatile memory, such as a backup RAM of the ECU 37. The map of the learning correction value EGRAdp is divided into multiple learning areas (for example, A1-A9) of which parameters are an opening degree OD of the EGR valve 31 and the fresh-air flow rate. The learning correction value EGRAdp is stored in each learning area. The learning correction value EGRAdp in each learning area is updated according to the current opening degree OD of the EGR valve 31 and the current fresh-air flow rate.

The EGR valve model is corrected based on the updated learning correction value EGRAdp.

When the answer is YES in step 116, the procedure proceeds to step 119 in which estimated-EGR-error learning flag LnrEGRerr is set to “1”.

When the answer is YES in step 110, the procedure proceeds to step 120 in which the EGR-ratio Regr [%] is computed.

Specifically, the mass flow rate Gair [g/sec] of the fresh-air, which is obtained from the fresh-air flow rate Gafm [g/rev] detected with the air flow meter 14, is substituted into the formula (4). Further, the intake air temperature t [° C.] and the atmospheric pressure P [atm] detected with a pressure sensor (not shown) are substituted into the formula (4), whereby the volume flow rate Vair [L/sec] is obtained.

Moreover, the mass flow rate Gegr [g/sec] derived form the estimated EGR-gas flow rate Gegr.est [g/rev], the temperature Tin [° C.], and the pressure Pin [kPa] detected by the intake pressure sensor 36 are substituted into the formula (6), whereby the volume flow rate Vegr [L/sec] of EGR-gas is calculated.

Then, the volume flow rate Vair [L/sec] and the volume flow rate Vegr [L/sec] are substituted into the formula (5), whereby the EGR-ratio Regr [%] is obtained.

According to the above described embodiment, when the EGR valve 31 is fully closed and the EGR-gas flow rate is zero, the total gas flow rate is computed based on the intake air pressure detected by the intake pressure sensor 36 by using of the intake valve model. The error of the total gas flow rate is learned and corrected based on the total gas flow rate and the fresh-air flow rate detected by the airflow meter 14. Therefore, the error of the total gas flow rate due to production tolerance and/or aged deterioration (model error of the intake valve model) can be corrected, so that the computation accuracy of total gas flow rate can be improved.

Then, when the EGR valve 31 is opened, the total gas flow rate introduced into the cylinders is computed based on the intake air pressure detected by the intake pressure sensor 36 by using of the intake valve model. Further, the ECU 37 computes an actual EGR-gas flow rate based on the total gas flow rate and the fresh-air flow rate detected by the airflow meter 14. Also, by using of the EGR valve model, the estimated EGR-gas flow rate is computed based on the fresh-air flow rate and the opening degree of the EGR valve 31. Based on a difference between the actual EGR-gas flow rate and the estimated EGR-gas flow rate, the error of the estimated EGR-gas flow rate (model error of the EGR valve model) can be corrected. Thus, the computation accuracy of the estimated EGR-gas flow rate can be improved.

Since the EGR ratio is computed based on the volume fraction of the estimated EGR-gas flow rate, the EGR ratio can be computed more accurately than a case that the EGR ratio is computed based on the mass fraction, as shown in FIG. 8. The control accuracy of a control conducted based on the EGR ratio can be improved. For example, a control accuracy of the EGR-gas flow rate, and a correction accuracy of the ignition timing can be enhanced.

It should be noted that the fresh-air flow rate can be estimated based on the intake air pressure and/or a correction amount of air-fuel ratio.

Also, the present disclosure can be applied to a high-pressure-loop (HPL) type EGR apparatus in which the exhaust gas is re-circulated from upstream of the exhaust turbine in the exhaust pipe to downstream of the compressor in the intake pipe.

The present disclosure can be applied to an engine provided with a mechanical supercharger or an electrical supercharger.

Also, the present disclosure can be applied to an engine having no supercharger.

What is claimed is:

1. An EGR controller for an internal combustion engine, comprising:
an EGR valve controlling an exhaust gas flow rate recirculating from an exhaust passage into an intake passage through an EGR passage;
an intake air flow rate obtaining portion detecting or estimating a fresh-air flow rate flowing through the intake passage;
an intake pressure detecting portion detecting an intake air pressure;
a total-flow-rate computing portion computing a total gas flow rate flowing into a cylinder of the internal combustion engine, based on the intake air pressure;
an actual-EGR computing portion computing an actual EGR-gas flow rate based on the total gas flow rate and the fresh-air flow rate;
an estimated-EGR computing portion computing an estimated EGR-gas flow rate flowing through the EGR valve by means of an EGR valve model simulating a behavior of a recirculated exhaust gas passing through the EGR valve in the EGR passage;
a first learning correction portion learning and correcting an error of the estimated EGR-gas flow rate based on the actual EGR-gas flow rate and the estimated EGR-gas flow rate; and
an EGR-ratio computing portion computing an EGR ratio based on volume fractions of the estimated EGR-gas flow rate and the fresh-air flow rate.

2. An EGR controller for an internal combustion engine according to claim 1, further comprising:
a second learning correction portion learning and correcting an error of the total gas flow rate based on the total gas flow rate and the fresh-air flow rate while the EGR valve is closed.
